(19) United States
(12) Patent Application Publication
(10) Pub. No.: US 2019/0202529 A1
(43) Pub. Date: Jul. 4, 2019

(54) DEVICE FOR ATTACHING A COUPLING DEVICE TO A FREE-FLOATING OBJECT

(71) Applicant: Technische Universität Berlin, Brrlin (DE)

(72) Inventor: Sebastian Ritz, Berlin (DE)

(21) Appl. No.: 16/331,406

(22) PCT Filed: Sep. 11, 2017
(86) PCT No.: PCT/EP2017/072738

§ 371 Date: Mar. 7, 2019

(30) Foreign Application Priority Data
Sep. 14, 2016 (DE) 10 2016 117 311.8

(51) Int. Cl. B63B 21/20; B63B 21/04; B66C 1/42; B66C 13/02; B66C 1/62; B66C 13/46; B66C 23/52

(52) U.S. Cl. CPC B63B 21/20; B63B 21/04; B66C 1/427; B66C 23/52; B66C 1/62; B66C 13/46; B66C 13/02

(57) ABSTRACT

A device is proposed for attaching a coupling device to a free-floating object, for example free-floating articles or free-floating persons. The device has: at least one first connection end, which can be connected to a load-receiving end of a lifting device; a coupling device for attachment to a free-floating object; a load-receiving connection between the first connection end and the coupling device; and a guiding device, which is separate from the load-receiving connection, connects the first connection end to the coupling device and is designed to guide the coupling device relative to the first connection end.

### TECHNICAL FIELD

The present invention relates to a device for attaching a coupling device to a free-floating object, for example free-floating articles or free-floating persons. Such a device can be deployed on a ship or on an offshore structure for example.

### BACKGROUND

Watercraft or floating articles are, for example, introduced or launched into the water from the deck of a ship and then recovered again. Such a launch and recovery system (LARS) is generally provided with a coupling device which connects to the watercraft or the floating article so that it can be launched and retrieved by a lifting device connected thereto.

The safe recovery of free-floating objects, such as watercraft or floating devices is made more difficult by the movements of the ship and the free-floating objects relative to each other. The attachment of a crane hook or fastening a comparable coupling device is currently a problem which has not yet satisfactorily resolved. In order to prevent damage through collisions the free-floating article is at a safe distance from the ship. Attaching the coupling device is generally carried out manually, for example by a seaman on the ship who guides the coupling device to the free-floating object with a rod.

Alternatively ships can launch a net or an underwater cage, also known as a garage. The floating device then manoeuvres autonomously into the net or the garage. The floating device is therefore not gripped but is caught and retrieved. However for this suitable manoeuvrability of the floating device is necessary.

Another possibility of recovery is the ejection of a recovery line from the floating device. This rises to the surface and can be caught and brought in with a hook or suchlike from on board the ship. For this the floating device requires a corresponding device for ejecting a recovery line.

In the manual method a coupling device is attached to a free-floating object by a seaman on a ship for example. He often requires several attempts and the work is physically exerting and time-consuming. Moreover, this method is associated with a high risk as the person carrying it out can go overboard or can be hit by swinging loads on the ship, for example by parts of the lifting device.

The special solutions for catching in an underwater cage or recovery using a recovery line place high demands on the floating device to be recovered. There is no reliable general solution for attaching a coupling device to a free-floating object. Furthermore, these solutions are relatively large and heavy and take up much cargo space or loading capacity.

The objective of the present invention is therefore to attach a coupling element to a free-floating object so that it can be recovered by a lifting device.

### Solution According to the Invention

The aforementioned problem is solved by a device according to claim 1 and a watercraft according to claim 13. Advantageous embodiments are set out in the dependent claims.

According to an embodiment the problem is solved by a device for attaching a coupling device to a free-floating object, for example free-floating articles or free-floating persons, comprising: at least one first connection end which can be connected to a load-receiving end of a lifting device, a load-receiving (or load-bearing) connection between the first connection end and the coupling device and a guiding device separate from the load-receiving connection which connects the connection end to the coupling device and is configured to guide the coupling device relative to the first connection end.

The device serves to lead the coupling device specifically to a free-floating object, for example free-floating articles, watercrafts, floating devices or persons, and bring about coupling or attaching of the coupling device to the free-floating object. Through attaching the coupling device the object is connected to the lifting device.

Typically the guiding device is functionally separate from the load-receiving connection. The guiding device can be described as a guiding branch of the device which forms a connection parallel to a load branch between the first connection end and the coupling device. The term “parallel connection” is to be understood functionally and not geometrically here. The load branch is formed by the load-receiving connection. The guiding device thus forms a “by-pass” to the load-receiving connection.

These two branches allow a functional separation between the functions of carrying of the load by the load-receiving connection and the function of guiding the coupling device to the free-floating object.

The coupling device typically forms a second connection end of the device. The second connection end of the device is for coupling to the free-floating object. The first connection end of the device is for coupling and connecting to the lifting device.

The load branch, formed by the load-receiving connection, essentially serves to take up the load of the object coupled to the coupling device. In the simplest case the load-receiving device can be a load rope which is sufficiently dimensioned to take up the load of the object and, for example, to pull the object out of the water. However, the load-receiving connection can also be a chain and in general be formed by a flexible connection element which on the one hand is sufficiently dimensioned in order, in particular, to take up the weight load of the object, and on the other hand allows free movement of the coupling device relative to the first connection end.

The load-receiving connection therefore connects the first connection end with the second connection end. Additionally and typically separately to this, the guiding device connects the first connection end with the second connection end. The position of the second connection end, i.e. of the coupling device relative to the first connection end is defined by at least partially controlling by the guiding device. The guiding device can guide the second guiding end relative to the first guiding end.

In this way it is possible to move the coupling device by means of the guiding device to the still free-floating object and bring about coupling of the coupling device with the free-floating object. In contrast to the load-receiving connection, the guiding device does not have to take up or bear the load of the free-floating object. This is taken over by the load-receiving connection. The guiding device only has to be configured so that it can safely bear the load, i.e. the weight, of the coupling device and guide the coupling device in a controlled manner to the free-floating object. In this way it is possible to configure the guiding device in a compact and lightweight fashion.

As the guiding device only has to move the coupling device only relatively small reaction moments (reaction torque) occur. It is therefore possible to move the coupling device relatively quickly so that the coupling device can relatively easily track the free-floating object.

The guiding device allows at least a controlled one-dimensional movement of the coupling device relative to the first connection end. Typically the guiding device is at least configured for a controlled two-dimensional movement of the coupling device relative to the first connection endent and preferably for a controlled three-dimensional movement, i.e. in all spatial directions.

The controlled one-dimensional movement of the coupling device relative to the first connection end is generally related to reference system in which the lifting device rests. If, for example, the first connection end is the end of a crane cable and the device for attaching a coupling device is fastened thereto, the deflection of the crane cable including the device is also a controlled movement according to an embodiment.

The guiding device therefore comprises at least one first actuator. This can be configured, for example, to perform a controlled linear movement or rotation. For example, pneumatic linear actuators can be used like pneumatic muscles as actuators as they have a comparatively low weigh and high power to weight ratio. As a result of this such actuators can also perform relative rapid movements, which is of advantage for the controlled tracking and bringing the coupling device into the proximity of the free-floating object.

Free-floating objects are, in particular, considered to be objects that are not permanently mechanically connected to the lifting device.

Free-floating objects can float on the surface of the water, partially in or completely under the water. They could for example be: manned or unmanned boats or submarines, floating devices or measuring instruments, freight items, boxes, containers, barrels, flotsam or persons. The free-floating objects can weigh from a few kilograms to several tonnes.

Free-floating objects can be manoeuvrable and, for example, have their own propulsion system. However, they can also be non-manoeuvrable. They are subject to the current, the waves and the wind and change their position and location relative to the lifting device and to the coupling device.

Due to a wave movement, for instance, the free-floating object moves. In addition, the lifting device, which is, for example, fastened to or form part of a ship, can also move as a result of the wave movement. Consequently the free-floating object and the lifting device move relative to each other. The amplitude and frequency of this relative movement can fluctuate. Through controlled guiding of the coupling device by the guiding device this relative movement can be countered and the movement of the coupling device harmonised with the movement of the free-floating object, or their movements can at least be aligned. In other words, even if the lifting device and the free-floating object undergo a large movement relative to each other, it can be ensured by the guiding device that the relative movement between the coupling device and the free-floating object is relatively small. This is supported by a guiding device that is light in term of weight.

The guiding device itself does not bear the load of the object, but only the load of the coupling device. Accordingly the guiding device can therefore be configured to be relatively compact. Through this costs can be saved.

For comparison reference should be made to a solution in which, for example, a robotic arm takes over the attachment and also the lifting of the free-floating object. Accordingly, this robotic arm must therefore be configured in a sturdy manner in order to bear the load of the object. Through this the robotic arm also becomes sluggish and does not permit fast movements to be carried out.

In contrast, the guiding device only has to move the coupling device safely. Therefore the guiding device can be equipped with smaller, lighter and more cost-effective components. Furthermore, such a guiding device also allows faster movements so that the guiding device can also follow an object that is moving a great deal due to the wave motion and can move the coupling device to the object better and more reliably.

According to an embodiment the guiding device can assume a configuration known as the park configuration in which the load of the free-floating object is practically entirely taken up by the load-receiving connection, but the guiding device is largely relieved of the load. Through this it is possible that after coupling has taken place the guiding device assumes the park configuration and the load is taken up by the load-receiving connection.

For example, the park configuration can be such that the guiding device has a distance between the first and the second connection end (coupling device) which in itself is greater than the distance of the load-receiving connection between these two ends if the load-receiving connection were not present. If, for example, the adjustable length of the guiding device has a maximum length that is greater than the maximum length of the load-receiving connection, the guiding device can be “relieved” up to the maximum length of the load-receiving guiding device and then no longer bears any load itself. The coupling device, which is then typically already attached to the objects, is then also borne by the load-receiving connection.

A conceivable possibility is, for example, to implement the guiding device by way of at least one pneumatic muscle which has a maximum extent that is greater than the maximum extent of the load-receiving connection, for example a rope. After coupling has taken place the muscle can be relaxed. Through its thus occurring extension the rope is tensioned but the muscle relieved.

Alternatively it is possible for the load-receiving connection to be shortened in order to take up the load of the object including the coupling device and to relieve the guiding device.

The liquid in which the free-floating object is floating can be, for example, salt water, seawater, fresh water, brackish water or also waste water or treated water such as chlorinated water. Objects floating in oil or mixtures of water and oil are also in keeping with the invention. For the sake of simplicity the description relates to free-floating objects in water without being restricted thereto.

According to an embodiment the device for attaching a coupling device can be assembled and disassembled. It can be assembled on a suitable lifting device and also disassembled again and stored. The device can therefore be provided as an add-on kit for lifting devices.

In the simplest case the device can, for example, be attached to a crane, for example attached to the crane hook with its first connection end. By way of the guiding device the coupling device is then guided to the free-floating object until coupling takes place. In doing so movement of the crane hook is not necessary but can take place to support coupling. After completed coupling either the length of the load-receiving connection is shortened or the guiding device assumes its park configuration. As a result the load-receiving connection is tensioned and the crane hook lifted. Through this the now coupled object can be lifted and recovered.

After recovery has taken place the device can be disassembled and stored.

The coupling device can be attached to the object and couple it. The coupling device is then connected to the object in a load-receiving manner. The coupling device is adapted to the floating object and can comprise, for example, a hook, a carabiner, a loop, a ring, a circular or cylinder coupling, a mushroom head lock, a gripper or a net. Depending on the type of coupling device attachment of the coupling device involves, for example, hooking, snapping in, threading in, encompassing, coupling, docking, gripping or entrapping.

According to an embodiment the coupling device has a securing mechanism which prevents unintentional detachment from the object after attachment. The securing mechanism can be self-locking when the coupling device comes into contact with the object. A securing mechanism is configured in such a way that it can only be opened by deliberate unlocking.

The securing mechanism can for example be a snap lock on a carabiner or a mushroom head lock.

According to an embodiment the guiding device can bear the load of the coupling device with an object coupled thereto.

According to an embodiment the load of the load-receiving connection is a multiple of that of the guiding device. The load of the load-receiving connection can, for example, be more than 5 times or more than 10 times the load of the guiding device.

The device attaches a coupling device to a free-floating object so that a load-receiving end of a lifting device is connected with the object. The lifting device is configured in such a way that it bears the dynamic tensile load of the object.

The lifting device can be configured so that it can lift or pull the object out of the water. According to an embodiment the lifting device can be a crane, a lifting or traction winch or similar. The load bearing capacity of such a lifting device corresponds to the force with which a mass of several hundred kilograms or several tonnes pulls on the lifting device in heavy seas.

According to an embodiment the load bearing capacity of the lifting device is at least 1 t or at least 5 t or at least 10 t.

The device for attaching a coupling device comprises a least one first connection end which can be connected to a load-receiving end of a lifting device. The load-receiving end of the lifting device is configured in such a way that it can be connected to the first connection end of the device for attaching a coupling device. According to an embodiment the load-receiving end of the lifting device is, for example, a hook, an eye, a plate or the end of a stable rope.

As has already been described above, the device for attaching a coupling device comprises a load-receiving connection between the first connection end and the coupling device. The load-receiving connection is configured so that it bears the tensile load of the object in the water. The load-receiving connection can be configured so that it bears the load that is required to lift or pull the object out of the water.

The load-receiving connection is not loaded when it is not bearing a load of an object. The load-receiving connection is loaded when it is bearing the load of an object.

The load-receiving end of the lifting device, the load-receiving connection and the coupling device form the load branch which can bear the dynamic tensile load of the object. The load branch is not loaded when the coupling unit is not connected to an object. The load branch is loaded when the coupling unit is coupled with one or more objects and the load of the object or the objects is taken up by the load branch.

According to an embodiment the guiding device is separate from the load-receiving connection and connects the first connection end of the device with the coupling device. The guiding device is configured in such a way that it can guide the coupling device relative to the first connection end. Preferably the guiding device is therefore separate from the load-receiving connection and connects the first connection end of the device to the coupling device. According to an embodiment the guiding device is parallel to the load-receiving device.

According to an embodiment the guiding device guides the coupling device when the loading branch is not loaded. This can take place in one or more spatial dimensions.

The range of movement within which the guiding device can move the coupling device defines a catching area for the free-floating object. Though the guiding of the coupling device by the guiding device the free-floating object can be caught and coupled in the catching area.

According to an embodiment the guiding device is configured in such a way that it can increase or decrease the distance between the first connection end and the coupling device. The guiding device can be configured so that through increasing the distance from the first connection end of the device to the coupling device it loads the load-receiving connection after coupling the coupling device to the object. In doing so, the guiding device can assume the aforementioned park configuration.

According to an embodiment the guiding device is configured in such a way that it can move the coupling device in a horizontal plane, i.e. a plane which is essentially parallel to the surface of the water. The coupling device is then guided relative to the first connection end. The lifting device rests in the reference system of the relative movement.

### BRIEF DESCRIPTION OF THE FIGURES

The invention will be described below in more detail by way of the examples of embodiment, without being restricted thereto. The attached figures only show schematic drawings and are not to scale.

FIGS. 1A and 1B show a side view and view from above of an embodiment of the invention.

FIGS. 2A and 2B show a form of embodiment of the invention with the loaded and not loaded load-receiving connection.

FIG. 3 shows a flow diagram for controlling a form of embodiment of a device for attaching a coupling device to a free-floating object.

### DETAILED DESCRIPTION OF EMBODIMENTS

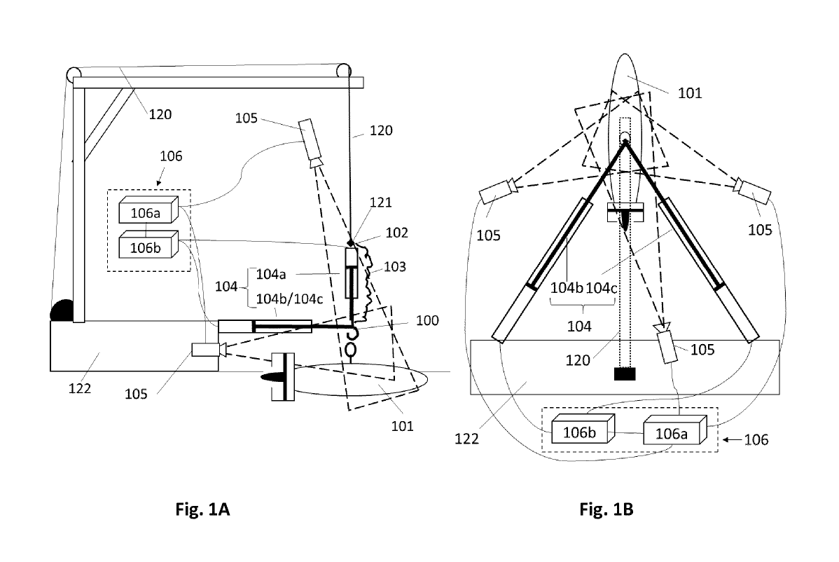

According to an embodiment FIGS. 1A and 1B show a device for attaching a coupling device 100 to a free-floating object 101, for example free-floating articles or free-floating persons, comprising: at least one connection end 102 which can be connected to a load-receiving end 121 of a lifting device 120, a load-receiving connection 103 between the first connection end 102 and the coupling device 100, and a guiding device 104 separate from the load-receiving connection 103 which connects the connection end 102 to the coupling device 100 and is configured to guide the coupling device 100 relative to the connection end 102.

According to an embodiment the connection for attaching a coupling device 100 to a free-floating object 101, for example free-floating articles or free-floating persons comprises: at least one first connection end 102 which can be connected to a load-receiving end 121 of a lifting device 120, a load-receiving connection 103 between the first connection end 102 and the coupling device 100, and a guiding device 104 separate from the load-receiving connection 103 which connects the connection end 102 with the coupling device 100 and is configured to guide the coupling device 100 relative to the first connection end 102 when the load-receiving connection 103 is not loaded.

According to an embodiment the lifting device 120 is fastened to a base 122. The base 122 of the lifting device 120 can be part of a watercraft or an off-shore structure or fixed in the vicinity of a waterway.

According to an embodiment the base 122 of the lifting device 120 is part of a ship. The lifting device 120 can be the A-frame of the ship or a crane.

The guiding device 104 can move the coupling device 100 in at least one and possibly in two or three spatial dimensions. The guiding device 104 guides the coupling device 100 relative to the first connection end 102.

The guiding device can guide the position of the coupling device 100. According to an embodiment the guiding device 104 can also change the location of the coupling device 100 relative to the object 101.

According to an embodiment the guiding device 104 is configured in such a way that it can vary the distance between the first connection end 102 and the coupling device 100. The guiding device 104 can be configured such that, through the variation in the distance from the first connection end 102 of the device to the coupling device 100, it loads the load-receiving connection 103 after coupling the coupling device to the object.

The guiding device 104 shown in FIGS. 1A and 1B comprises several linear actuators 104a, 104b, 104c. The first linear actuator 104a is arranged vertically to the surface of the water and connects the coupling unit 100 to the first connection end 102 of the device separately from the load-receiving connection 103. The second linear actuator 104b and the third linear actuator 104c are arranged horizontally in relation to the surface of the water. The horizontal actuators connect the coupling unit 100 to the first connection end 102 separately from the load-receiving connection 103 via the base of the lifting device 122 and the lifting device 120.

According to an embodiment the guiding device 104 comprises at least one first linear actuator 104a which connects the connection end to the coupling device.

According to an embodiment the guiding device 104 comprises at least one second linear actuator 104b with a first and a second end, wherein the first end forms a second connection end of the device for attaching the device relative to the lifting device 120 and the second end is connected to the coupling device 100.

According to an embodiment the guiding device 104 comprises at least two linear actuators 104b, 104c each with a first and a second end, wherein the first end of each linear actuator is attachable relative to the lifting device 120 and the second end of each linear actuator is connected to the coupling device 100.

Linear actuators can be selected from a group comprising: pneumatic or hydraulic muscles or cylinders, linear motors, stepper motors or combinations thereof.

Pneumatic linear actuators, for example pneumatic muscles can be deployed on ships as ships often already have a suitable pneumatic system, for example a conventional compressed air supply.

Depending on their inherent stability, for the pneumatic muscles a support device, consisting of telescopic pipes for example, may be required.

According to an embodiment the guiding device 104 has a robotic arm which can guide the coupling device 100. This robotic arm can comprise a plurality of movable axes. For example, this robotic arm is a pick-and-place robot.

According to an embodiment the device for attaching a coupling device 100 to free-floating object 101 has a recording device 105. The recording device 105 is configured so that it can determine the position of an object 101 or its location or both. The object 101 moves in the water through its own movement and the sea swell.

The position of the object 101 can, for example, be determined relative to the coupling device 100, relative to the lifting device 120 or relative to the base 122 of the lifting device.

The detection device 105 is configured in such a way that it can determine the position of the object or the location of the object or both. According to an embodiment the detection device 105 is configured in such a way that it can determine the position of the coupling device 100. From this the position of the object relative to the coupling device 100 can be determined.

According to an embodiment the recording device comprises one or more optical sensors for recording the position of the free-floating object. Optical sensors can, for example, be cameras in the optical or infrared range.

Through image evaluation of the optical sensors the position of the free-floating object in the catching area is determined. The position of the coupling device can be known or also determined in order to determine the relative position and/or location between the free-floating object and the coupling device therefrom. The control device then controls guiding device in such a way that the guiding device guides the coupling device to the free-floating object. The object can then be attached.

When the object is attached it can be recovered by the load branch of lifting device, load-receiving connection and coupling device.

According to an embodiment the device for attaching a coupling device to a free-floating object has a control device 106 for controlling the guiding device 104. The control device 106 is connected to the recording device 105 in such a way that it can process the recorded position of the free-floating object 101 and, if necessary, the position of the coupling device 100.

The position of the free-floating object 101 can be determined in the recording device 10 and forwarded to the control device 106. According to an embodiment the recording device 105 and control device 106 are combined in a joint component.

According to an embodiment the control device 106 is in two parts. The first part of the control device 106a is suitable for processing the data of the recording device and producing a movement forecast of the object 101 and/or the coupling device 100. The second part of the control device 106b controls the guiding device.

According to an embodiment in the control device the position and/or the location of the free-floating object and, as the case may be, the position and/or location of the coupling device are processed. In addition a forecast of the movement and future position and/or location of the object and/or the coupling device can be established. From this, software-based regulation (closed-loop control) of the guiding device can be set up.

According to an embodiment the control device controls the guiding device mechanically. This takes place on the basis of the regulation. The mechanical controlling of the guiding device is dependent on the type of guiding device and includes, for example, the application of a voltage to operate an electric motor or the opening and/or closing of pressure valves of a pneumatic or hydraulic device.

According to an embodiment the control device controls the guiding device in such a way that when the load-receiving connection is not loaded the guiding device guides the coupling device to the free-floating object in dependence on the position recorded by the recording device.

According to an embodiment the regulation and the mechanical control of the guiding device by the control device takes place automatically when the free-floating object is within the reach of the coupling device.

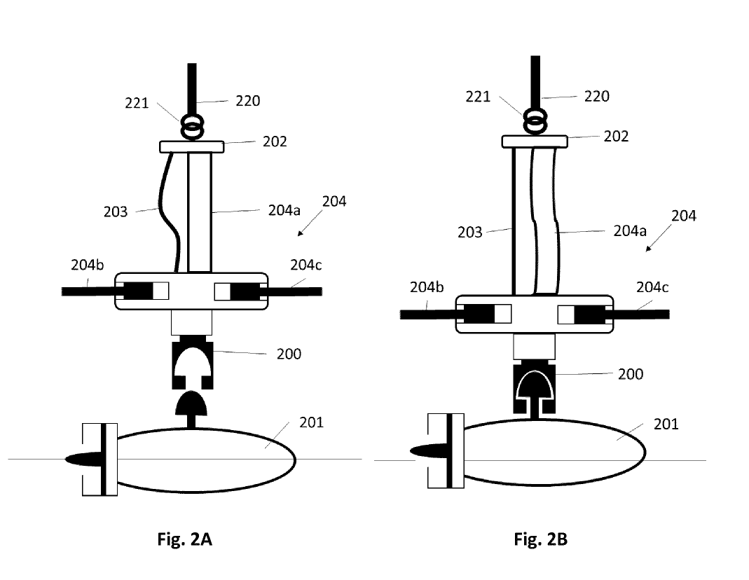

FIG. 2A shows a load-receiving end 221 of a lifting device 220. The load-receiving end 221 is connected to a device for attaching a coupling device 200 to a free-floating object 201 at a first end 202. In addition, the device comprises a load-receiving connection 203 between the first connection end 202 and the coupling device 200 and a guide device 204 separate from the load-receiving connection 203 which connects the connection end 202 to the coupling device 200 and is configured to guide the coupling device 200 relative to the first connection end 202.

According to an embodiment the guiding device 201 in FIGS. 2A and 2B comprises at least one first linear actuator 204a. The first linear actuator 204a is vertically arranged and can increase or decrease the distance between the first connection end 202 and the coupling device 200. Through this the load-receiving connection is 203 is loaded or unloaded. The guide device 204 also has at least one second linear actuator 204b with a first and a second end, wherein the first end forms a second connection end of the device for attaching the device relative to the lifting device 220 and the second end is connected to the coupling device 200.

Furthermore, the guide device 204 in FIGS. 2A and 2B comprises at least two linear actuators 204b, 204c each with a first and a second end, wherein the first end of each linear reactor is attachable relative to the lifting device and the second end of each linear actuator is connected to the coupling device 200. These are both horizontal linear actuators.

According the embodiment in FIGS. 2A and 2B all three linear actuators 204a, 204b, 204c have pneumatic cylinders or pneumatic muscles.

According to an embodiment the guiding device comprises at least one or at least two articulated arms which each have a first and a second end, wherein the first end of each articulated arm is connected to the first connection end and the second end of each articulated arm is connected to the coupling device. The articulated arms allow a one-dimensional or multi-dimensional freedom of movement of the coupling device through the guiding device.

According to the form of embodiment in FIGS. 2A and 2B the coupling device 200 has a mushroom head lock and the free-floating object 201 the corresponding counterpart so that the coupling device 200 can couple to the free-floating object 201.

FIG. 2A shows the device for attaching coupling device 200 to a free-floating object 201 before attaching the coupling device 200. The guiding device 204 guides the coupling device 200 to the free-floating object 201. The vertical muscle 204a guides the coupling device 200 to the free-floating object 201. The vertical muscle 204a is part of the guiding device 204. In FIG. 2A it is contracted and reduces the distance between the first connection end 202 and the coupling device 200. The load branch formed of the lifting device 220, first connection end 202, load-receiving connection 203 and coupling device 200 is not loaded.

FIG. 2B shows the device for attaching a coupling device 200 to a free-floating object 201 after coupling on the coupling device 200. The object 201 is now coupled and no longer free-floating. The vertical muscle 204a is not contracted and in comparison with FIG. 2A increases the distance between the first connection end 202 and the coupling device 200. The load branch formed of the lifting device 220, first connection end 202, load-receiving connection 203 and coupling device 200 is loaded. In particular, the load-receiving connection 203 is loaded with the load of the coupled object 201.

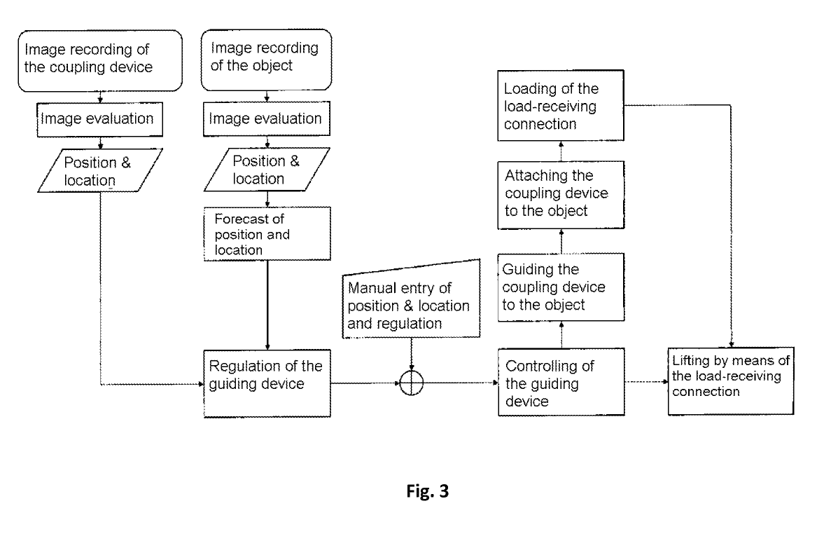

FIG. 3 shows a flow diagram for operating a form of embodiment of a device for attaching a coupling device to a free-floating object. In this form of embodiment the recording device is configured in such a way that is can produce image recordings both of the coupling device and also the object. Through the subsequent image evaluation, the position and location of the coupling device and of the object are determined in parallel. Assisted by computer a forecast can be produced for the position and location of the object from the current movement. On the basis of this computer-assisted regulation of the guiding device takes place.

The position of the free-floating object can, according to an embodiment, be determined by way of a motion capture method. In this the object and the coupling device are provided with optical markers. The markers are recorded by optical cameras of the recording device and processed in the recorded images. By way of the marker movements in the individual camera images the position and/or location of the markers can be calculated in 3D using triangulation. Alternatively the markers can be dispensed with if the object or the coupling device can be tracked by pattern recognition.

According to an embodiment image recording, image evaluation, determination of the position and location, forecasting the position and location and regulation of the guiding device take place in a common component. This component then comprises at least parts of the recording device as well as at least parts of the control device.

Alternatively the position and the location of the object can be recorded manually, for example by a seaman on board the ship. Regulation can also take place manually by a way of a type of joystick or other suitable input device. The seaman then regulates/controls the guiding device while he is observing the object and the coupling device.

According to the form of embodiment in FIG. 3 the control device mechanically controls the guiding device. In doing so it converts the instructions by the regulation into mechanical actions. The guiding device then guides the coupling device to the object. After the coupling device has been attached the load-receiving connection can be loaded with the load of the object. Finally the object can be lifted via load-receiving connection by the lifting device.

According to an embodiment the device for attaching a coupling device is dismantled and is only connected to a lifting device when required. The dismantled device for attaching a coupling device is stored on board a ship and is fastened to a lifting device when required. The device for attaching a coupling device can, for example, be stored in a shipping container.

Further forms of embodiment are produced through various combinations of a lifting device and a device for attaching a coupling device as described in the previous sections. The lifting device has a load-receiving end which can be connected to the first connection end of the device.

A lifting device with a load receiving end can, for example, have a hook on which the device for attaching a coupling device can be suspended.

Further forms of embodiment are brought about in a watercraft with a lifting device and a device for attaching a coupling device through various combinations of the forms of embodiment of the device as described above.

According to an embodiment the lifting device of the watercraft can be connected to the device for attaching a coupling device. To use the device for attaching a coupling device the lifting device is connected to the device for attaching a coupling device.

The lifting device of the watercraft can be a crane or an A-frame for example.

### REFERENCES

100, 200—Coupling device
101, 201—Free-floating object
102, 202—First connection end
103, 203—Load-receiving connection
104, 204—Guiding device
104a/b/c; 204 a/b/c—Linear actuators
105—Recording device
106—Control device
106a, 106b—Parts of the control device
120, 220—Lifting device
121, 221—Load-receiving end of the lifting device
122—Base of the lifting device

1. A device for attaching a coupling device to a free-floating object, for example free-floating articles or free-floating persons, comprising:
at least one first connection end which can be connected to a load-receiving end of a lifting device;
a coupling device for attaching to a free-floating object;
a load-receiving connection between the first connection end and the coupling device; and
a guiding device separate to the load-receiving connection which connects the first connection end to the coupling device and which is configured to guide the coupling device relative to the first connection end.

2. The device according to claim 1 further comprising:
a recording device for recording the position and/or the location of the object; and
a control device for controlling the guiding device, wherein the guiding device is configured in such a way that when the load-receiving connection is not loaded the guiding device guides the coupling device to the free-floating object as a function of the position recorded by the recording device.

3. The device according to claim 2 wherein the recording device comprises optical sensors and from the signal of the optical sensors determines the relative position of the free-floating object.

4. The device according to claim 1, wherein the guiding device comprises at least one first linear actuator which connects the first binding end to the coupling device.

5. The device according to claim 4 wherein the guiding device comprises at least one second linear actuator with a first and a second end, wherein the first end forms a second connection end of the device for attaching the device relative to the lifting device and the second end is connected to the coupling device.

6. The device according to claim 1 wherein the guiding device comprises at least two linear actuators each with a first and a second end, wherein the first end of each linear actuator is attachable relative to the lifting device and the second end of each linear actuator is connected to the coupling device.

7. The device according to claim 4 wherein the linear actuators are selected from a group comprising pneumatic or hydraulic muscles or cylinders, linear motors, stepped motors and combinations thereof.

8. The device according to claim 1 wherein the guiding device comprises at least one articulated arm or at least two articulated arms which each have a first and a second end, wherein the first end of each articulated arm is connected with a first connection end and the second end of each articulated arm is connected to the coupling device.

9. The device according to claim 1 wherein the coupling device comprises a securing mechanism, for example a snap lock, for preventing unintentional detachment of the coupling device from the free-floating object after coupling.

10. The device according to claim 1 wherein the coupling device comprises a mushroom head lock.

11. The device according to claim 1 wherein the coupling device comprises a ring, a loop, a gripper or a net.

12. A lifting device with a load-receiving end and a device according to claim 1 wherein the device is fastened to the load-receiving end with its first connection end.

13. A watercraft with a lifting device having a load-receiving end and with a device for attaching a coupling device according to claim 1, wherein the load-receiving end of the lifting device can be detachably connected to the device for attaching a coupling device or can be detachably attached relative to the lifting device.

14. The watercraft according to claim 13 wherein the load-receiving end of the lifting device is connected to the device for attaching a coupling device.

15. The watercraft according to claim 13 wherein the lifting device comprises an A-frame or a crane of the watercraft.
